(19) United States
(12) Patent Application Publication
(10) Pub. No.: US 2011/0014931 A1
(43) Pub. Date: Jan. 20, 2011

(54) METHOD FOR DELIVERING A SHORT MESSAGE IN A MOBILE COMMUNICATIONS SYSTEM

(75) Inventors: Peter Jessen, Bonn (DE); Martin Sohn, Ochtendung (DE)

Correspondence Address: BAKER & DANIELS LLP;111 E. WAYNE STREET, SUITE 800, FORT WAYNE, IN, 46802, US

(73) Assignee: T-MOBILE INTERNATIONAL AG, Bonn (DE)

(21) Appl. No.: 12/446,653

(22) PCT Filed: Oct. 25, 2007
(86) PCT No.: PCT/EP07/09265

§ 371 Date: Aug. 25, 2009

(30) Foreign Application Priority Data
Oct. 26, 2006 (DE) 10 2006 051 007.0

(51) Int. Cl. H04W 4/12

(52) U.S. Cl. 455/466

(57) ABSTRACT

The invention relates to a method for delivering a short message in a mobile communications system, in which the short message sent from a mobile station is received by an SMS-Service-Centre, SMS-C, and forwarded to a corresponding recipient, wherein the SMS-C is addressed by means of an SMS-C address in the mobile communications system. The invention is distinguished by the fact that an SMS-C address recognized as erroneous is corrected on the part of the mobile communications system, and the delivery of the short message is continued with the corrected SMS-C address.

The invention relates to a method for delivering a short message in a mobile communications system in accordance with the features of the preamble of claim 1.

Packet-oriented user data can be transported from and to the mobile station (MS) on the signaling level of the protocol architecture of a digital GSM mobile communications system. The point-to-point short message service SMS (Short Message Service) offers one possibility.

FIG. 1 schematically shows the facilities of a GSM mobile communications network for the carrying out of an SMS short message service. The short messages are transported in the store-and-forward operation via an SMS Service Center (SMS-SC usually referred to as SC or SMS-C for Short Message Service Center). This SMS-C 20 receives the short messages from a mobile station, MS 10 and forwards them to the corresponding recipient. The SMS-C 20 transports the short messages within the GSM network via SS7 to the mobile subscriber, but also possesses in general TCP/IP connection possibilities with the Internet, so that SMS can also be sent by Internet to the SMS-C 20. For the delivery of a Short Message Mobile Originating (SMS-MO) from a mobile station 10 to other subscribers (mobile phone, fixed network) the SMS-C 20 is addressed by means of an SMS-C address in the mobile telephony network.

The SMS-C address is stored in the mobile equipment 10. This SMS-C address is transmitted with an SMS-MO from the mobile equipment 10 to the responsible mobile switching center 14 (Mobile Switching Center: MSC). Short messages can also be routed via a GPRS switching center, SGSN, 12.

In the MSC 14 the SMS-MO is routed to the SMS-C 20 with the help of the SMS-C address. In case the SMS-C address is not correctly configured in the mobile equipment 10, the MSC 14 cannot address the SMS-C 20 or the SMS arrives at the SMS-C 20 and it is determined there that the sent SMS-C address does not match/correspond to the real SMS-C address. In both cases the SMS-MO cannot be successfully delivered.

The SMS-C is as a rule coupled to an SMS gateway switching center. Such gateway components are e.g. the SMS-Gateway-MSC (SMS-GMSC) for the downlink direction (SMS to the mobile station) or the SMS-Internetworking-MSC 18 (SMS-IWMSC) for the uplink direction (SMS from the mobile station). Within the GSM network an SMS is forwarded between the MSCs via the MAP interface (Mobile Application Part) and the connections of the SS7 (Signaling System No. 7) lying beneath.

The short message service is described among other things with the specifications 3GPPTS 23.040: “Technical Realization of the Short Message Service (SMS)” and 3GPPTS 29.002: “Mobile Application Part (MAP)”.

It is the object of the invention to specify a method which permits a correct delivery of a short message (SMS-MO) even in the case of an incorrectly configured SMS-C address in the mobile station.

This problem is solved in accordance with the invention by the features of the independent claim.

Preferred embodiments and further advantageous features of the invention are specified in the dependent claims.

A method for delivering a short message in a mobile communication system is described in which the short message sent from a mobile station is received by an SMS Service Center, SMS-C, and forwarded to a corresponding recipient, wherein the SMS-C is addressed by means of an SMS-C address in the mobile communications system.

In accordance with the invention an SMS-C address recognized as erroneous will be corrected on the part of the mobile communications system, after which the delivery of the short message is continued with the corrected SMS-C address.

The inventive method comprises two preferred embodiments.

In a first embodiment of the invention a test takes place and if necessary a correction of an SMS-C address recognized as erroneous takes place in the mobile switching station MSC prior to the forwarding of the short message SMS to the SMS-C. The correction of the address takes place with the help of an address list (Table), in which a series of “valid” SMS-C addresses are stored. The address list can be kept in the MSC or in a database connected to the MSC.

In a second embodiment of the invention a correction of the SMS-C address takes place after a rejection of an SMS-MO by MSC or SMS-C. After that a renewed sending of the short message SMS takes place with the corrected SMS-C address.

In the case of both methods the SMS-MO delivery in the case of erroneous SMS-C address is guaranteed by a default SMS-C address. As a result of this the success rate of the SMS service for the mobile telephone customers is increased.

Exemplary embodiments of the invention will be described more closely with the help of the drawings.

FIG. 1 shows schematically the network components of a mobile communications system which is used in short message transmission.

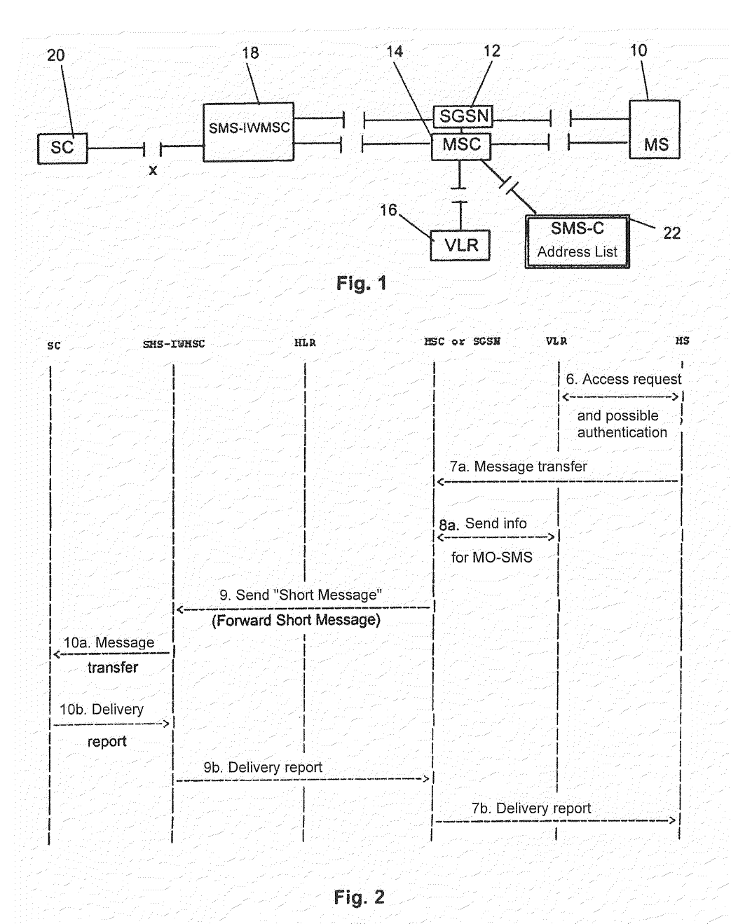

FIG. 2 shows the message history between the network components shown in FIG. 1 in the case of a successful delivery of a short message.

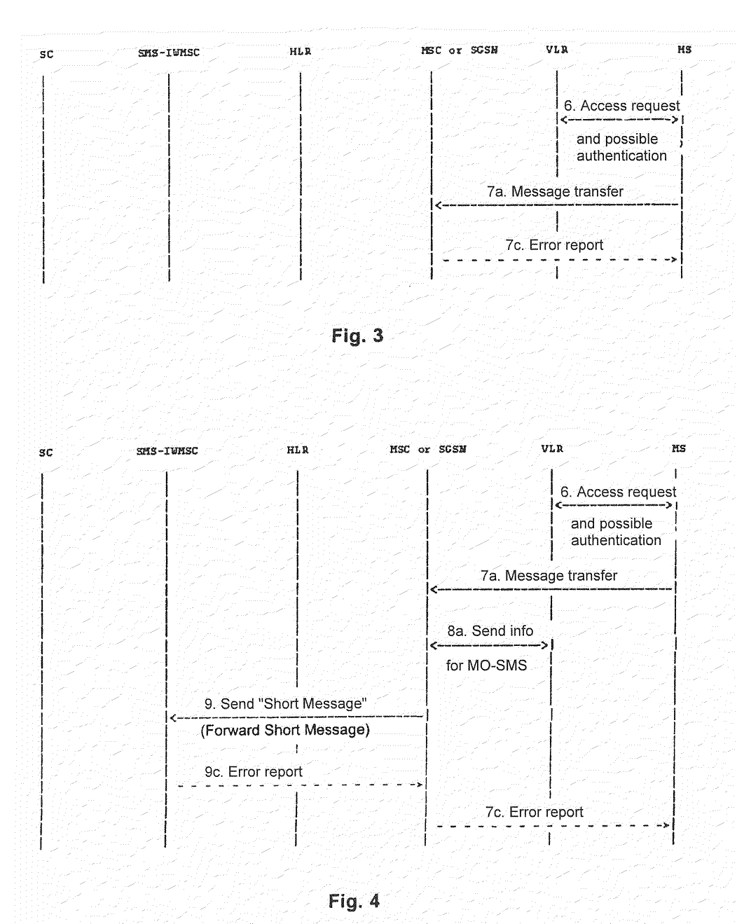

FIG. 3 shows the message history between the network components in the case of an occurring error in the mobile switching center MSC or the network node SGSN.

FIG. 4 shows the message history between the participating network elements in the case of an occurring error in the interworking switching center.

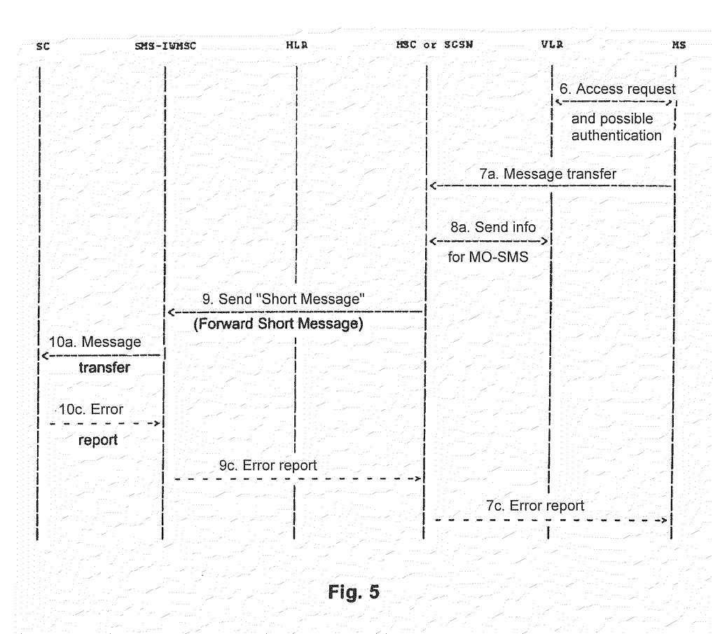

FIG. 5 shows the message history between the participating network elements in the case of an occurring error in the short message service center SMS-C.

The network elements required in the case of the delivery of a short message in a mobile communications system have already been explained in the introductory part of the description with reference to FIG. 1.

FIG. 2 describes the case of a successful delivery of a short message and shows the message exchange between the participating network elements. In accordance with Step 6 first an access request takes place on the part of the mobile station MS at the visitor location register VLR of the mobile telephone network and a possible authentication procedure for authentication of the mobile station vis-a-vis the network. If these procedures have been successfully completed, the mobile station MS can send a short message to a predetermined recipient. The short message is first transmitted to the responsible switching center MSC or SGSN (Step 7a). In Step 8a a communication takes place between the switching center and the visitor register VLR for the purpose of corresponding information for the delivery of the short message. In Step 9 then the short message is sent from the switching center MSC or SGSN to an interworking switching center switching center SMS-IWMSC and from here further in Step 10a to the short message center (Step 10a). In Step 10b the short message center confirms the receipt of the short message, wherein the confirmation message is returned to the sending mobile station via the switching centers, as Steps 9b and 7b show.

FIG. 3 shows the message history of an erroneous delivery of a short message. Steps 6 and 7a are first carried out at the same time, as described in connection with FIG. 2. However, it is assumed that the mobile station MS is using an erroneous or impermissible SMS-C address here, which will be recognized as erroneous in the mobile switching center MSC, so that a forwarding to an SMS-C is not possible. The mobile switching center MSC thereupon sends an error report 7c back to the sending mobile station.

FIG. 4 shows a further example of a possible error case in the case of the delivery of a short message. Steps 6, 7a, 8a and 9 are carried out as described in connection with FIG. 2. It is assumed that the mobile station MS is using an erroneous or impermissible SMS-C address. The interworking switching center SMS-IWMSC however recognizes the erroneous or impermissible SMS-C address and sends as an answer an error report 9c back to the responsible switching center MSC or SGSN. This error report is returned to the mobile station by the MSC as error report 7c.

FIG. 5 shows a further possible error case in the case of the delivery of a short message. Steps 6, 7a, 8a, 9 and 10a correspond to the steps described in FIG. 2 in the case of the delivery of the short message to the short message center SC. The short message center however recognizes an erroneous addressing with the help of the SMS-C address and sends an error report to the mobile station (Steps 10c, 9c and 7c) via the switching center SMS-IWMSC, the switching center MCS or SGSN.

In all of the above described cases of an error in the delivery of a short message the inventive method can produce relief as described in the following:

In a first embodiment of the invention a test takes place and if necessary a correction of an erroneous or impermissible SMS-C address in the MSC 14 prior to the sending of an SMS to the SMS-C 20. The correction of the SMS-C address takes place by means of an address list in the form of a table 22 with valid SMS-C addresses, to which the MSC 14 can have access. As can be gathered from FIG. 1, the address list 22 is stored in the MSC 14 or SGSN 12 or is connected to the MSC 14 or SGSN 12 as an independent database.

The valid SMS-C addresses in the table 22 are entered in the MSC 14. The first entry in this table 22 corresponds to a “default” SMS-C address.

Example of the SMS-C address list in the MSC:

MSC SMS-C Address List

| | |
|---|---|
| SMS-C Addr 0 *) | 491710760000 |
| SMS-C Addr 1 | 491710770000 |
| SMS-C Addr 2 | 4917100750000 |
| . . . | |
| SMS-C Addr X | 4917100740000 |

*) The first valid entry corresponds to the “default” SMS-C address, e.g. 491710760000.

Protocol 1 shows an excerpt from which a Forward SM message between the MSC 14 and the SMS-C 20, wherein the relevant parameters for the invention are highlighted in boldface type. The footnotes^{1), 2), 3), 4), 5)} refer to messages and parameters of the subsequent SMS-MO signaling.

In the message “Forward SM”¹⁾ the network operator checks in the mobile subscriber identification “IMSI” whether it is a matter of a subscriber of the proper mobile telephone network. This can be tested with the help of the MCC parameters contained in the IMSI (Mobile Country Code) and MNC (Mobile Network Code). In the case of a subscriber of the German D1 network (T-Mobile) the “MCC” and the “MNC”³⁾ of the IMSI must for example correspond to the numbers 262 01. If it is determined that it is not a subscriber of the proper network, but rather e.g. is a roaming subscriber, the program does not intervene into the normal SMS signaling.

If it is a proper subscriber, that is if “MCC” and “MNC”³⁾ in the “IMSI” parameter²⁾ of the “Forward SM”¹⁾ message correspond to 262 01, the SMS-C address present in the message “SC DA Address Signals”⁴⁾ from the “Service Centre Addr DA”⁵⁾ parameter of the message “Forward SM”¹⁾ is compared with the SMS-C address list 22 in the MSC 14.

If the SMS-C address “SC DA Address Signals”³⁾ is present in the MSC SMC-C address list 22, the SMS with the original address is forwarded to the SMS-C 20 by the MSC 14 via the SMS-IWMSC 18.

If the SMS-C address “SC DA Address Signals”³⁾ of the SMC-C is not contained in the SMS-C address list 22, this false or erroneous SMS-C address is replaced by the MSC 14 with the first entry of the MSC SMS-C address list 22 and the SMS is sent to the SMS-C 20 with this corrected (default) SMS-C address “SC DA Address Signals”³⁾.

Protocol 1:
Excerpt from the Forward SM Message with the relevant parameters:

| \|**B96*** | \|Data | \|62 5e 48 04 fa 04 6e e5 6b 1a 28... | \| |
|---|---|---|---|
| \|3GPP 29.002 (MAP) Version 4.8.0 (MAP) BEG (= Begin) | | | \| |
| \|Begin | | | \| |
| \|01100010 | \|Tag | \|(APPL C [2]) | \| |
| \|01011110 | \|Length | \|94 | \| |
| \|1 Origination Transaction ID | | | \| |
| \|01001000 | \|Tag | \|(APPL P [8]) | \| |
| \|00000100 | \|Length | \|4 | \| |
| \|***B4*** | \|Orig Trans ID | \|4194594533 | \| |
| \|2 DialoguePortion | | | \| |
| \|01101011 | \|Tag | \|(APPL C [11]) | \| |
| \|00011010 | \|Length | \|26 | \| |
| \|2.1 DialogueExternal | | | \| |
| \|00101000 | \|Tag | \|(UNIV C External) | \| |
| \|00011000 | \|Length | \|24 | \| |
| \|2.1.1 DialogueObjectID | | | \| |
| \|00000110 | \|Tag | \|(UNIV P Obj Identifier) | \| |
| \|00000111 | \|Length | \|7 | \| |
| \|00000000 | \|Authority | \|CCITT Recommendation | \| |
| \|00010001 | \|Name Form | \|q | \| |
| \|10000110 | \|Rec Number | \|7 | \| |
| \|00000101 | \|Rec Number | \|73 | \| |
| \|00000001 | \|AS | \|1 | \| |
| \|00000001 | \|Dialog-AS | \|Dialogue PDU | \| |
| \|00000001 | \|Version | \|1 | \| |
| \|2.1.2 DialoguesingleASN1 | | | \| |
| \|10100000 | \|Tag | \|(CONT C [0]) | \| |
| \|00001101 | \|Length | \|13 | \| |
| \|2.1.2.1 DialogueRequest | | | \| |
| \|01100000 | \|Tag | \|(APPL C [0]) | \| |
| \|00001011 | \|Length | \|11 | \| |
| \|2.1.2.1.1 Application Context Name | | | \| |
| \|10100001 | \|Tag | \|(CONT C [1]) | \| |
| \|00001001 | \|Length | \|9 | \| |
| \|2.1.2.1.1.1 ACN Object Id | | | \| |
| \|00000110 | \|Tag | \|(UNIV P Obj Identifier) | \| |
| \|00000111 | \|Length | \|7 | \| |
| \|0000---- | \|ObjId | \|CCITT | \| |
| \|----0100 | \|Organization | \|Identified-organization | \| |
| \|00000000 | \| | \|ETSI | \| |
| \|00000000 | \|Domain | \|Mobile Domain | \| |
| \|00000001 | \|Mobile Subdomain | \|GSM-Network | \| |
| \|00000000 | \|Common Component ID | \|AC-ID | \| |
| \|00010101 | \|Application Context | \|Short Msg MO-Relay | \| |
| \|00000011 | \|Version | \|Version3 | \| |
| \|3 Component Portion | | | \| |
| \|01101100 | \|Tag | \|(APPL C [12]) | \| |
| \|00111010 | \|Length | \|58 | \| |
| \|3.1 Invoke | | | \| |
| \|10100001 | \|Tag | \|(CONT C [1]) | \| |
| \|00111000 | \|Length | \|56 | \| |
| \|3.1.1 Invoke ID | | | \| |
| \|00000010 | \|Tag | \|(UNIV P Integer) | \| |
| \|00000001 | \|Length | \|1 | \| |
| \|00000001 | \|Invoke ID value | \|1 | \| |
| \|3.1.2 Local Operation | | | \| |
| \|00000010 | \|Tag | \|(UNIV P Integer) | \| |
| \|00000001 | \|Length | \|1 | \| |
| \|00101110 | \|Operation Code | \|Forward SM 1) | \| |
| \|3.1.3 Parameter Sequence | | | \| |
| \|00110000 | \|Tag | \|UNIV C Sequence (of)) | \| |
| \|00110000 | \|Length | \|48 | \| |
| \|3.1.3.1 Service Centre Addr DA 5) | | | \| |
| \|10000100 | \|Tag | \|(CONT P [4]) | \| |
| \|00000111 | \|Length | \|7 | \| |
| \|1------- | \|Extension Indicator | \|No Extension | \| |
| \|-001---- | \|Nature of Address | \|International number | \| |
| \|----0001 | \|Numbering Plan Indicator | \|ISDN/Telephony No plan (E.164) | \| |
| \|***B6*** | \|SC DA Address Signals 4) | \|‘491700750000’ | |
| \|3.1.3.2 MSISDN | | | \| |
| \|10000010 | \|Tag | \|(CONT P [2]) | \| |
| \|00000111 | \|Length | \|7 | \| |
| \|1------- | \|Extension Indicator | \|No Extension | \| |
| \|-001---- | \|Nature of Address | \|International number | \| |
| \|----0001 | \|Numbering Plan Indicator | \|ISDN/Telephony No plan (E.164) | \| |
| \|***B6*** | \|MS ISDN Address Signals | \|‘491715932xxx’ | \| |
| \|3.1.3.3 SM RP UI | | | \| |
| \|00000100 | \|Tag | \|(UNIV P OctetString) | \| |
| \|00010010 | \|Length | \|18 | \| |
| \|**B18*** | \|SM RP UI | \|35 2e 0c 91 94 71 21 60 61 79 00. . . | \| |
| \|3.1.3.4 IMSI 2) | | | \| |
| \|00000100 | \|Tag | \|(UNIV P OctetString) | \| |
| \|00001000 | \|Length | \|8 | \| |
| \|**b60*** | \|MCC + KNC + MSIN 3) | \|‘262011949000042’ | \| |
| \|1111---- | \|FILLER | \|15 | \| |
| \|P-GSM 03.40 (SMPT) Version 3.5.0 (SMTP) SMSB (= SMS-SUBMIT) | | | \| |
| \|SMS-SUBMIT | | | \| |
| \|-------1 | \|Message type indicator | \|1 | \| |
| \|-----10- | \|Spare | \|- unknown/undefined - | \| |
| \|---10--- | \|(Validity Period format | \|TP-VP present, integer | \| |
| \|001----- | \|Spare | \|- unknown/undefined - | \| |
| \|Message Reference | | | \| |
| \|00101110 | \|TP-Message Reference | \|46 | \| |
| \|Destination Address | | | \| |
| \|00001100 | \|Address Length | \|12 | \| |
| \|----0001 | \|Number plan | \|ISDN/telephony numbering plan | \| |
| \|-001---- | \|Type of number | \|International number | \| |
| \|1------- | \|Extension bit | \|No Extension | \| |
| \|***B6*** | \|Destination Address | \|‘491712061xxx’ | \| |
| \|Protocol Identifier | | | \| |
| \|---00000 | \|SM-AL protocol | \|0 | \| |
| \|--0----- | \|Telematic interworking | \|No interwork, SME-to-SME prot | \| |
| \|00------ | \|Spare | \|0 | \| |
| \|Data Coding Scheme | | | \| |
| \|00000000 | \|TP-Data-Coding Scheme | \|0 | \| |
| \|Validity Period | | | \| |
| \|10100111 | \|Validity Period | \|167 | \| |
| \|TP-User-Data | | | \| |
| \|00000100 | \|User Data Length | \|4 | \| |
| \|***B4*** | \|User Data | \|“Test” | \| |

In accordance with a modified embodiment of the invention a correction of a false or erroneous SMS-S address takes place only after a rejection by the MSC 14 or the SMS-C 20. Subsequently a renewed sending of the SMS with the corrected SMC-S address takes place.

Protocol 2 shows an excerpt from the Forward SM message between the MSC 14 and the SMS-C with the parameters relevant for the invention. The footnotes^{1), 2), 3), 4), 5), 6)} refer to messages and parameters of the subsequent SMS-MO signaling.

A “default” SMS-C address is entered in the MSC 14.

It is assumed that the MSC 14 sends the “Forward SM”¹⁾ message with a false SMC-C address “SC DA Address Signals”²⁾ to the SMS-C 20. The MSC 14 cannot route the SMS to the SMS-C 20 due to a false SMS-C address or the SMS-C 20 recognizes with the help of the SMS-C address “SC DA Address Signals”²⁾ the fact that the SMS-C address is not correct. The MSC 14 or the SMS-C answers the “Forward SM”¹⁾ message with an “error code”³⁾.

This “error code”³⁾ can for example be one of the following:

System Failure

Unknown SC Address

Network out of order

These “error codes”³⁾ are partially dependent on the MSC or the SMS-C implementations of the device manufacturers.

If one of these “error codes”³⁾ or another error code is sent back to the MSC 14, the MSC 14 sends a new “Forward SM”¹⁾ to the SMS-C corrected in the following manner:

In the “Forward SM” ¹⁾ message the program checks in the “IMSI”⁴⁾ parameter whether it is a subscriber of the proper network of the network operator. In the case of a subscriber of the German D1 network (T-Mobile) the “MCC” and the “MNC”³⁾ of the IMSI must correspond for example to the numbers 262 01. In case it is determined that it is not a subscriber of the proper network, but rather e.g. is a roaming subscriber, no corrected “Forward SM”¹⁾ message will be sent to the SMS-C.

In case it is a proper subscriber, that is if “MCC” and “MNC”⁵⁾ in the “IMSI”⁴⁾ parameter of the “Forward SM”¹⁾ message corresponds to 262 01, the SMS-C address “SC DA Address Signals”²⁾ from the “Service Centre Addr DA”⁶⁾ parameter of the “Forward SM”¹⁾ message is overwritten with the “default” SMC-C address defined in the MSC. This corrected “Forward SM”¹⁾ message will be sent to the SMS-C 20 once more.

The MSC 14 sets a flag for this SMS transaction:

In case the already corrected “Forward SM” 1) is answered with an “error code” 3) again, in the case of a set flag no further correction of the SMS-C address “SC DA Address Signals” 2) takes place and there will be no renewed sending of the “Forward SM” 1) message to the SMS-C 20. After that the flag in the MSC 14 for this SMS transaction will be reset.

Protocol 2
Excerpt from the Forward SM Message with the relevant parameters:
Message with the wrong SMS-C address

| \|3GPP 29.002 (MAP) Version 4.8.0 (MAP) BEG (= Begin) | | | \| |
|---|---|---|---|
| \|Begin | | | \| |
| \|01100010 | \|Tag | \|(APPL C [2]) | \| |
| \|01100000 | \|Length | \|96 | \| |
| \|1 Origination Transaction ID | | | \| |
| \|01001000 | \|Tag | \|(APPL P [8]) | \| |
| \|00000100 | \|Length | \|4 | \| |
| \|***B4*** | \|Orig Trans ID | \|4194609381 | \| |
| \|2 DialoguePortion | | | \| |
| \|01101011 | \|Tag | \|(APPL C [11]) | \| |
| \|00011010 | \|Length | \|26 | \| |
| \|2.1 DialogueExternal | | | \| |
| \|00101000 | \|Tag | \|(UNIV C External) | \| |
| \|00011000 | \|Length | \|24 | \| |
| \|2.1.1 DialogueObjectID | | | \| |
| \|00000110 | \|Tag | \|(UNIV P Obj Identifier) | \| |
| \|00000111 | \|Length | \|7 | \| |
| \|00000000 | \|Authority | \|CCITT Recommendation | \| |
| \|00010001 | \|Name Form | \|q | \| |
| \|10000110 | \|Rec Number | \|7 | \| |
| \|00000101 | \|Rec Number | \|73 | \| |
| \|00000001 | \|AS | \|1 | \| |
| \|00000001 | \|Dialog-AS | \|Dialogue PDU | \| |
| \|00000001 | \|Version | \|1 | \| |
| \|2.1.2 DialoguesingleASN1 | | | \| |
| \|10100000 | \|Tag | \|(CONT C [0]) | \| |
| \|00001101 | \|Length | \|13 | \| |
| \|2.1.2.1 DialogueRequest | | | \| |
| \|01100000 | \|Tag | \|(APPL C [0]) | \| |
| \|00001011 | \|Length | \|11 | \| |
| \|2.1.2.1.1 Application Context Name | | | \| |
| \|10100001 | \|Tag | \|(CONT C [1]) | \| |
| \|00001001 | \|Length | \|9 | \| |
| \|2.1.2.1.1.1 ACN Object Id | | | \| |
| \|00000110 | \|Tag | \|(UNIV P Obj Identifier) | \| |
| \|00000111 | \|Length | \|7 | \| |
| \|0000---- | \|ObjId | \|CCITT | \| |
| \|----0100 | \|Organization | \|Identified-organization | \| |
| \|00000000 | \| | \|ETSI | \| |
| \|00000000 | \|Domain | \|Mobile Domain | \| |
| \|00000001 | \|Mobile Subdomain | \|GSM-Network | \| |
| \|00000000 | \|Common Component ID | \|AC-ID | \| |
| \|00010101 | \|Application Context | \|Short Msg MO-Relay | \| |
| \|00000011 | \|Version | \|Version3 | \| |
| \|3 Component Portion | | | \| |
| \|01101100 | \|Tag | \|(APPL C [12]) | \| |
| \|00111100 | \|Length | \|60 | \| |
| \|3.1 Invoke | | | \| |
| \|10100001 | \|Tag | \|(CONT C [1]) | \| |
| \|00111010 | \|Length | \|58 | \| |
| \|3.1.1 Invoke ID | | | \| |
| \|00000010 | \|Tag | \|(UNIV P Integer) | \| |
| \|00000001 | \|Length | \|1 | \| |
| \|00000001 | \|Invoke ID value | \|1 | \| |
| \|3.1.2 Local Operation | | | \| |
| \|00000010 | \|Tag | \|(UNIV P Integer) | \| |
| \|00000001 | \|Length | \|1 | \| |
| \|00101110 | \|Operation Code | \|Forward SN 1) | \| |
| \|3.1.3 Parameter Sequence | | | \| |
| \|00110000 | \|Tag | \|(UNIV C Sequence (of)) | \| |
| \|00110010 | \|Length | \|50 | \| |
| \|3.1.3.1 Service Centre Addr DA 6) | | | \| |
| \|10000100 | \|Tag | \|(CONT P [4]) | \| |
| \|00000111 | \|Length | \|7 | \| |
| \|1------- | \|Extension Indicator | \|No Extension | \| |
| \|-001---- | \|Nature of Address | \|International number | \| |
| \|----0001 | \|Numbering Plan Indicator | \|ISDN/Telephony No plan (E.164) | \| |
| \|***B6*** | \|SC DA Address Signals 2) | \|‘420603052000’ | \| |
| \|3.1.3.2 MSISDN | | | \| |
| \|10000010 | \|Tag | \|(CONT P [2]) | \| |
| \|00000111 | \|Length | \|7 | \| |
| \|1------- | \|Extension Indicator | \|No Extension | \| |
| \|-001---- | \|Nature of Address | \|International number | \| |
| \|----0001 | \|Numbering Plan Indicator | \|ISDN/Telephony No plan (E.164) | \| |
| \|***B6*** | \|MS ISDN Address Signals | \|‘491715932542’ | \| |
| \|3.1.3.3 SM RP UI | | | \| |
| \|00000100 | \|Tag | \|(UNIV P OctetString) | \| |
| \|00010100 | \|Length | \|20 | \| |
| \|**B20*** | \|SM RP UI | \|35 32 0c 91 94 71 21 60 61 79 00... | \| |
| \|3.1.3.4 IMSI 4) | | | \| |
| \|00000100 | \|Tag | \|(UNIV P OctetString) | \| |
| \|00001000 | \|Length | \|8 | \| |
| \|**b60*** | \|MCC + MNC + MSIN 5) | \|‘262011949000042’ | \| |
| \|1111---- | \|FILLER | \|15 | \| |
| \|P-GSM 03.40 (SMTP) Version 3.5.0 (SMTP) SMSB (= SMS-SUBMIT) | | | \| |
| \|SMS-SUBMIT | | | \| |
| \|-------1 | \|Message type indicator | \|1 | \| |
| \|-----10- | \|Spare | \|- unknown/undefined - | \| |
| \|---10--- | \|Validity Period format | \|TP-VP present, integer | \| |
| \|001----- | \|Spare | \|- unknown/undefined - | \| |
| \|Message Reference | | | \| |
| \|00110010 | \|TP-Message Reference | \|50 | \| |
| \|Destination Address | | | \| |
| \|00001100 | \|Address Length | \|12 | \| |
| \|----0001 | \|Number plan | \|ISDN/telephony numbering plan | \| |
| \|-001---- | \|Type of number | \|International number | \| |
| \|1------- | \|Extension bit | \|No Extension | \| |
| \|***B6*** | \|Destination Address | \|‘491712061697’ | \| |
| \|Protocol Identifier | | | \| |
| \|---00000 | \|SM-AL protocol | \|0 | \| |
| \|--0----- | \|Telematic interworking | \|No interwork, SME-to-SME prot | \| |
| \|00------ | \|Spare | \|0 | \| |
| \|Data Coding Scheme | | | \| |
| \|00000000 | \|TP-Data-Coding Scheme | \|0 | \| |
| \|Validity Period | | | \| |
| \|10100111 | \|Validity Period | \|167 | \| |
| \|TP-User-Data | | | \| |
| \|00000110 | \|User Data Length | \|6 | \| |
| \|***B6*** | \|User Data | \|“Test 3” | \| |

Error report (“Return error code”) from the MSC or the SMS-C

| \|ITU-T WHITE BOOK SCCP (SCCP) UDT (= Unitdata) | | | \| |
|---|---|---|---|
| \|Unitdata | | | \| |
| \|1010---- | \|Signalling Link Selection | \|10 | \| |
| \|00001001 | \|SCCP Message Type | \|9 | \| |
| \|----0001 | \|Protocol Class | \|Class 1 | \| |
| \|0000---- | \|Message Handling | \|No special options | \| |
| \|00000011 | \|Pointer to parameter | \|3 | \| |
| \|00001110 | \|Pointer to parameter | \|14 | \| |
| \|00011001 | \|Pointer to parameter | \|25 | \| |
| \|Called address parameter | | | \| |
| \|00001011 | \|Parameter Length | \|11 | \| |
| \|-------0 | \|Point Code Indicator | \|PC absent | \| |
| \|------1- | \|Subsystem No. Indicator | \|SSN present | \| |
| \|--0100-- | \|Global Title Indicator | \|Has transln, n-plan, code, natur | \| |
| \|-1------ | \|Routing Indicator | \|Route on DPC + Subsystem No. | \| |
| \|0------- | \|For national use | \|0 | \| |
| \|00001000 | \|Subsystem number | \|MSC | \| |
| \|00000000 | \|Translation Type | \|Not used | \| |
| \|----0010 | \|Encoding Scheme | \|BCD, even number of digits | \| |
| \|0001---- | \|Numbering Plan | \|ISDN/Telephony (E.164/E.163) | \| |
| \|-0000100 | \|Nat. of Address Indicator | \|International number | \| |
| \|0------- | \|Spare | \|0 | \| |
| \|***B6*** | \|Called Address Signals | \|‘491710120000’ | \| |
| \|Calling address parameter | | | \| |
| \|00001011 | \|Parameter Length | \|11 | \| |
| \|-------0 | \|Point Code Indicator | \|PC absent | \| |
| \|------1- | \|Subsystem No. Indicator | \|SSN present | \| |
| \|--0100-- | \|Global Title Indicator | \|Has transln, n-plan, code, natur | \| |
| \|-0------ | \|Routing Indicator | \|Route on Global Title | \| |
| \|0------- | \|For national use | \|0 | \| |
| \|00001000 | \|Subsystem number | \|MSC | \| |
| \|00000000 | \|Translation Type | \|Not used | \| |
| \|----0010 | \|Encoding Scheme | \|BCD, even number of digits | \| |
| \|0001---- | \|Numbering Plan | \|ISDN/Telephony (E.164/E.163) | \| |
| \|-0000100 | \|Nat. of Address Indicator | \|International number | \| |
| \|0------- | \|Spare | \|0 | \| |
| \|***B6*** | \|Calling Address Signals | \|‘420603052000’ | \| |
| \|Data parameter | | | \| |
| \|00111110 | \|Parameter length | \|62 | \| |
| \|**B62*** | \|Data | \|64 3c 49 04 fa 04 a6 e5 6b 2a 28... | \| |
| \|3GPP 29.002 (MAP) Version 4.8.0 (MAP) END (= End) | | | \| |
| \|End | | | \| |
| \|01100100 | \|Tag | \|(APPL C [4]) | \| |
| \|00111100 | \|Length | \|60 | \| |
| \|1 Destination Transaction ID | | | \| |
| \|01001001 | \|Tag | \|(APPL P [9]) | \| |
| \|00000100 | \|Length | \|4 | \| |
| \|***B4*** | \|Dest Trans ID | \|4194609381 | \| |
| \|2 DialoguePortion | | | \| |
| \|01101011 | \|Tag | \|(APPL C [11]) | \| |
| \|00101010 | \|Length | \|42 | \| |
| \|2.1 DialogueExternal | | | \| |
| \|00101000 | \|Tag | \|(UNIV C External) | \| |
| \|00101000 | \|Length | \|40 | \| |
| \|2.1.1 DialogueObjectID | | | \| |
| \|00000110 | \|Tag | \|(UNIV P Obj Identifier) | \| |
| \|00000111 | \|Length | \|7 | \| |
| \|00000000 | \|Authority | \|CCITT Recommendation | \| |
| \|00010001 | \|Name Form | \|q | \| |
| \|10000110 | \|Rec Number | \|7 | \| |
| \|00000101 | \|Rec Number | \|73 | \| |
| \|00000001 | \|AS | \|1 | \| |
| \|00000001 | \|Dialog-AS | \|Dialogue PDU | \| |
| \|00000001 | \|Version | \|1 | \| |
| \|2.1.2 DialoguesingleASN1 | | | \| |
| \|10100000 | \|Tag | \|(CONT C [0]) | \| |
| \|00011101 | \|Length | \|29 | \| |
| \|2.1.2.1 DialogueResponse | | | \| |
| \|01100001 | \|Tag | \|(APPL C [1]) | \| |
| \|00011011 | \|Length | \|27 | \| |
| \|2.1.2.1.1 Protocol Version | | | \| |
| \|10000000 | \|Tag | \|(CONT P [0]) | \| |
| \|00000010 | \|Length | \|2 | \| |
| \|00000111 | \|UnusedBits | \|7 | \| |
| \|1------- | \|Version 1 | \|Yes | \| |
| \|-0000000 | \|Filler | \|0 | \| |
| \|2.1.2.1.2 Application Context Name | | | \| |
| \|10100001 | \|Tag | \|(CONT C [1]) | \| |
| \|00001001 | \|Length | \|9 | \| |
| \|2.1.2.1.2.1 ACN Object Id | | | \| |
| \|00000110 | \|Tag | \|(UNIV P Obj Identifier) | \| |
| \|00000111 | \|Length | \|7 | \| |
| \|0000---- | \|ObjId | \|CCITT | \| |
| \|----0100 | \|Organization | \|Identified-organization | \| |
| \|00000000 | \| | \|ETSI | \| |
| \|00000000 | \|Domain | \|Mobile Domain | \| |
| \|00000001 | \|Mobile Subdomain | \|GSM-Network | \| |
| \|00000000 | \|Common Component ID | \|AC-ID | \| |
| \|00010101 | \|Application Context | \|Short Msg MO-Relay | \| |
| \|00000011 | \|Version | \|Version3 | \| |
| \|2.1.2.1.3 ResultType | | | \| |
| \|10100010 | \|Tag | \|(CONT C [2]) | \| |
| \|00000011 | \|Length | \|3 | \| |
| \|2.1.2.1.3.1 Associate-Result | | | \| |
| \|00000010 | \|Tag | \|(UNIV P Integer) | \| |
| \|00000001 | \|Length | \|1 | \| |
| \|00000000 | \|Associate Result | \|Accepted | \| |
| \|2.1.2.1.4 ResultSourceDiagnostic | | | \| |
| \|10100011 | \|Tag | \|(CONT C [3]) | \| |
| \|00000101 | \|Length | \|5 | \| |
| \|2.1.2.1.4.1 DialogueServiceUser | | | \| |
| \|10100001 | \|Tag | \|(CONT C [1]) | \| |
| \|00000011 | \|Length | \|3 | \| |
| \|2.1.2.1.4.1.1 Dialogue Service User Value | | | \| |
| \|00000010 | \|Tag | \|(UNIV P Integer) | \| |
| \|00000001 | \|Length | \|1 | \| |
| \|00000000 | \|Dialogue Service User | \|Null | \| |
| \|3 Component Portion | | | \| |
| \|01101100 | \|Tag | \|(APPL C [12]) | \| |
| \|00001000 | \|Length | \|8 | \| |
| \|3.1 Return Error | | | \| |
| \|10100011 | \|Tag | \|(CONT C [3]) | \| |
| \|00000110 | \|Length | \|6 | \| |
| \|3.1.1 Invoke ID | | | \| |
| \|00000010 | \|Tag | \|(UNIV P Integer) | \| |
| \|00000001 | \|Length | \|1 | \| |
| \|00000001 | \|Invoke ID value | \|1 | \| |
| \|3.1.2 Local Error | | | \| |
| \|00000010 | \|Tag | \|(UNIV P Integer) | \| |
| \|00000001 | \|Length | \|1 | \| |
| \|00100010 | \|Error Code 3) | \|system Failure | \| |

### LIST OF REFERENCE SYMBOLS AND ABBREVIATIONS

6-10 (Signaling) messages
10 MS
12 SGSN
14 MSC
16 VLR
18 SMS-IWMSC
20 SC (SMS-C)
GSM Global System for Mobile Communication
GPRS Packet Radio System
MS Mobile Station
SMS Short Message Service
SMS-C SMS Service Center also SC
MSM-MO SMS-Mobile Originated
MSC Mobile Switching Center
SMS-IWMSC SMS Interworking-MSC
MAP Mobile Application Part
IMSI Internal Mobile Subscriber Identification
MCC Mobile Country Code
MNC Mobile Network Code
SGSN Serving GPRS Support Node
VLR Visitor Location Register
HLR Home Location Register

1. A method for delivering a short message in a mobile communications system, in which the short message sent from a mobile station (10) is received by an SMS-Service Center, SMS-C, (20), and forwarded to a corresponding recipient, wherein the SMS-C is addressed by means of an SMS-C address in the mobile communications system, characterized in that an SMS-C address recognized as erroneous is corrected on the part of the mobile communications system, and the delivery of the short message is continued with the corrected SMS-C address, wherein the erroneous SMS-C address is recognized as erroneous in a responsible mobile switching center (14, 18) with the help of an error occurring there or an error code returned by the SMS Service Center (20) and is replaced by the corrected SMS-C address.

2. The method according to claim 1, characterized in that the erroneous SMS-C address is recognized as erroneous in a responsible mobile switching center (14) and is replaced by a valid SMS-C address.

3. The method according to claim 1, characterized in that a comparison of the SMS-C address is performed in the mobile switching center (14) with several valid SMS-C addresses kept in an address list (22), and that this SMS-C address is recognized as erroneous if it is not contained in the address list.

4. The method according to claim 3, characterized in that the comparison is carried out prior to the delivery of the short message to the SMS Service Center (20).

5. The method according to claim 1, characterized in that the SMS-C address recognized as erroneous is replaced by a predetermined, valid SMS-C address kept in the address list (22).

6. The method according to claim 1, characterized in that the valid SMS-C address is kept in the mobile switching center (14).

7. The method according to claim 1, characterized in that the short message is transmitted anew to the SMS Service Center (20) with the corrected SMS-C address replaced by a valid SMS-C address.

8. The method according to claim 1, characterized in that the delivery of the short message is aborted if the corrected SMS-C address generates an error or error code again.

9. The method according to claim 1, characterized in that it will only be carried out in the case of subscribers for whom the mobile communications system constitutes the home network.

10. A system for delivering a short message in a mobile communications system according to the method of claim 1, comprising an SMS Service Center, SMS-C 920), for the receipt of a short message sent from a mobile station (10) and for the forwarding of the short message to a corresponding recipient, wherein the SMS-C is addressed by means of an SMS-C address in the mobile communications system, characterized by facilities (14) for the recognition of an erroneous SMS-C address and correction of this erroneous SMS-C address and for the continuation of the delivery of the short message with the corrected SMS-C address.

11. A data processing program with a program code which executes a method according to claim 1 on a data processing device.

12. A data processing program product which comprises a program code executable on a data processing device for the carrying out of the method according to any one of claim 1.

13. The method according to claim 2, characterized in that the SMS-C address recognized as erroneous is replaced by a predetermined, valid SMS-C address kept in the address list (22).

14. The method according to claim 3, characterized in that the SMS-C address recognized as erroneous is replaced by a predetermined, valid SMS-C address kept in the address list (22).

15. The method according to claim 4, characterized in that the SMS-C address recognized as erroneous is replaced by a predetermined, valid SMS-C address kept in the address list (22).

16. The method according to claim 2, characterized in that the short message is transmitted anew to the SMS Service Center (20) with the corrected SMS-C address replaced by a valid SMS-C address.

17. The method according to claim 3, characterized in that the short message is transmitted anew to the SMS Service Center (20) with the corrected SMS-C address replaced by a valid SMS-C address.

18. The method according to claim 4, characterized in that the short message is transmitted anew to the SMS Service Center (20) with the corrected SMS-C address replaced by a valid SMS-C address.

19. The method according to claim 5, characterized in that the short message is transmitted anew to the SMS Service Center (20) with the corrected SMS-C address replaced by a valid SMS-C address.

20. The method according to claim 6, characterized in that the short message is transmitted anew to the SMS Service Center (20) with the corrected SMS-C address replaced by a valid SMS-C address.
